(19) United States
(12) Patent Application Publication
(10) Pub. No.: US 2003/0066971 A1
(43) Pub. Date: Apr. 10, 2003

(54) Disinfecting device of a knife holder

(76) Inventor: Lin Wen Yen, Taipei City (TW)

Correspondence Address: Lin Wen Yen, 9F 3R, NO. 210, CHUNG HSUEH Rd., TAINAN CITY, TW

(21) Appl. No.: 09/976,758

(22) Filed: Oct. 8, 2001

(51) Int. Cl. G01N 23/00

(52) U.S. Cl. 250/455.11

(57) ABSTRACT

A disinfecting device of a knife holder includes an ultraviolet disinfecting lamp secured in a knife groove base of a knife holder consisting of a front shell and a rear shell and an upper cover. The upper cover has a plurality of insert holes provided spaced apart for knives to insert therein. A knife groove base having an open knife groove inside is fitted in the shell body and has a pull-push water-collecting tray fitted at a bottom side. Then, a fundamental base is positioned under the shell body and is collapsible for facilitating to be placed on a surface or on a table. An ultraviolet lamp is fixedly installed at a lower portion inside the knife groove base and covered around by a protective shade to prevent water from seeping in. The ultraviolet light of the ultraviolet lamp shines into the knife grooves and disinfects the knife blades therein.

### BACKGROUND OF THE INVENTION

This invention relates to a disinfecting device of a knife holder, particularly to one possible to exterminate the germs on the surface of the knife blades positioned in the insert groove of a knife holder so as to keep knives in a hygienic condition and ensure a user's health.

A conventional knife holder, as shown in FIG. 1, includes a bottom base 1, a knife base 10 and an upper cover 11 combined together. The knife base 10 has a plurality of insert grooves provided spaced apart for the knife blades of knives 12 to insert therein. After the knife blades are inserted in the insert grooves, the water sticking on them will drop down into a water-collecting groove 13 on the bottom base 1. But, as the conventional knife holder has no heat-drying or disinfecting device provided inside and the water in the water-collecting groove of the bottom base 1 cannot easily be poured out, germs is liable to multiply on the knife blades in the knife grooves, thus greatly affecting a user's health.

### SUMMARY OF THE INVENTION

The objective of the invention is to offer a disinfecting device of a knife holder, capable to exterminate the germs on the knife blades inserted in the insert grooves of a knife holder and keep knives in a sanitary condition.

The feature of the invention is that an ultraviolet disinfecting lamp is installed in the knife groove base of a knife holder to produce ultraviolet Light for exterminating germs on the knife blades in the knife groove in order to ensure a user's health.

### BRIEF DESCRIPTION OF DRAWINGS

This invention will be better understood by referring to the accompanying drawings, wherein:

FIG. 1 is an exploded perspective view of a conventional knife holder;

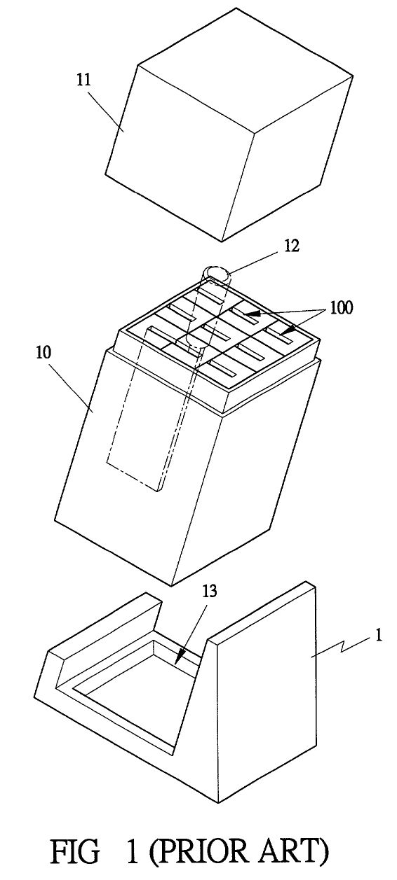

FIG. 2 is a perspective view of a knife holder with a disinfecting device in the present invention;

FIG. 3 is a rear cross-sectional view of the knife holder with a disinfecting device in the present invention;

FIG. 4 is a side cross-sectional view and a partially magnified cross-sectional view of the line I-I in FIG. 3;

FIG. 5 is a left side cross-sectional view of the knife holder with a disinfecting device in the present invention;

FIG. 6 is another side cross-sectional view of the knife holder with a disinfecting device in the present invention.

### DETAILED DESCRIPTION OF THE PREFERRED EMBODIMENT

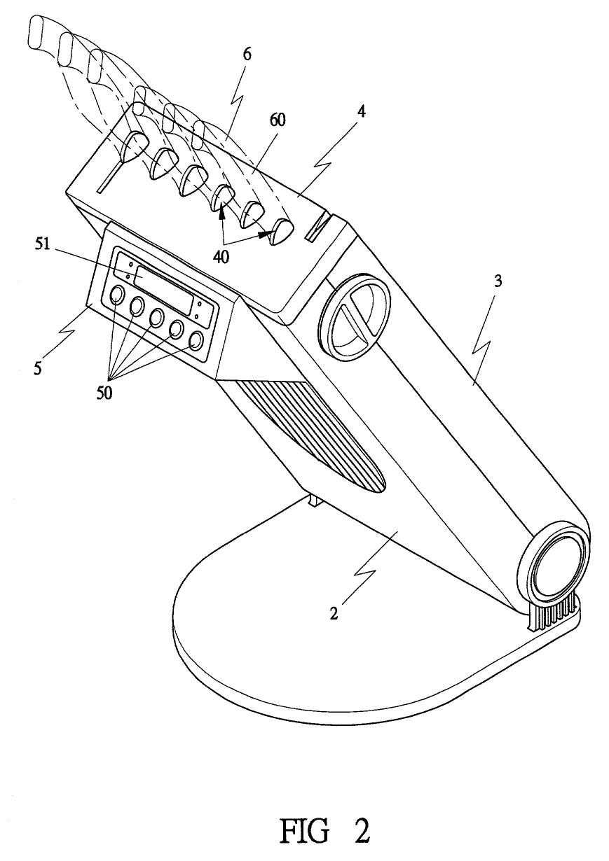

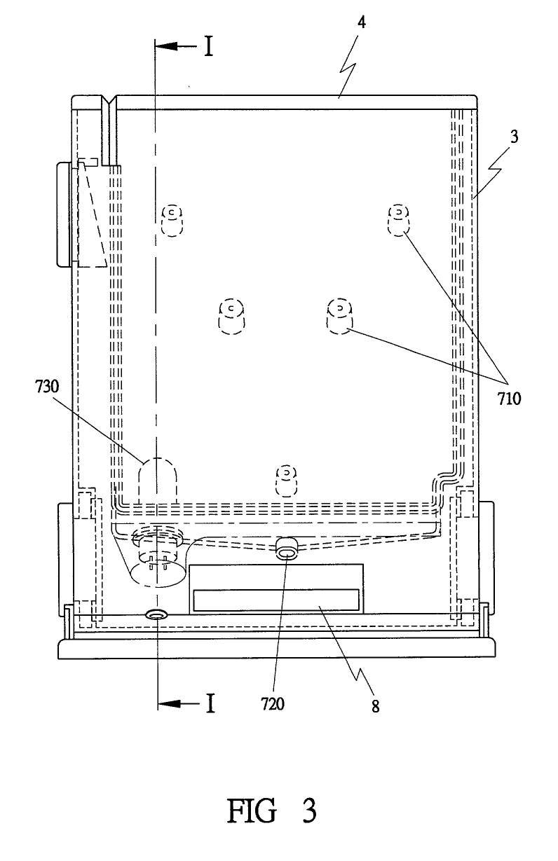

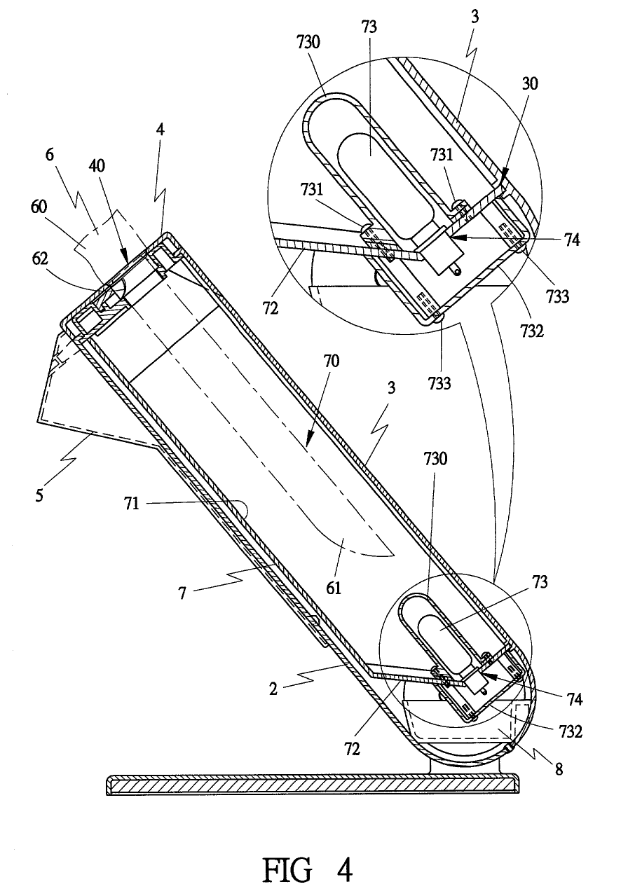

A preferred embodiment of a disinfecting device of a knife holder in the present invention, as shown in FIGS. 2, 3 and 4, includes an ultraviolet disinfecting lamp 73 contained in a knife groove base 7 of a knife holder consisting of a front shell 2, a rear shell 3, an upper cover 4 and a faceplates 5.

The front shell 2 and the rear 3 are combined to form a shell body covered by the upper cover 4. The upper cover 4 has a plurality of insert holes 40 provided spaced apart exactly for receiving a little portion of each knife handle 60 and keeping it steady therein, with the knife blade 61 inserted deeply into a knife groove 70 of a knife groove base 7. Further, a curved recess 62 is formed between the knife handle 60 and the knife blade 61 and a faceplate 5 having press buttons 50 and an indicating device 51 is provided fixed on a front surface of the front shell 2 and fixed together. The button 50 of the faceplate 5 is pressed to show on the indicating device 51 the operating condition of the knife holder.

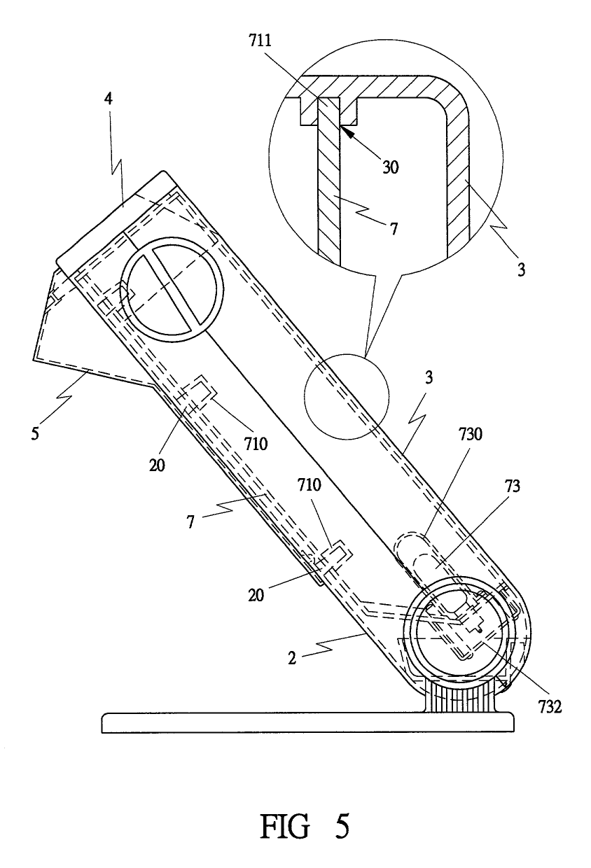

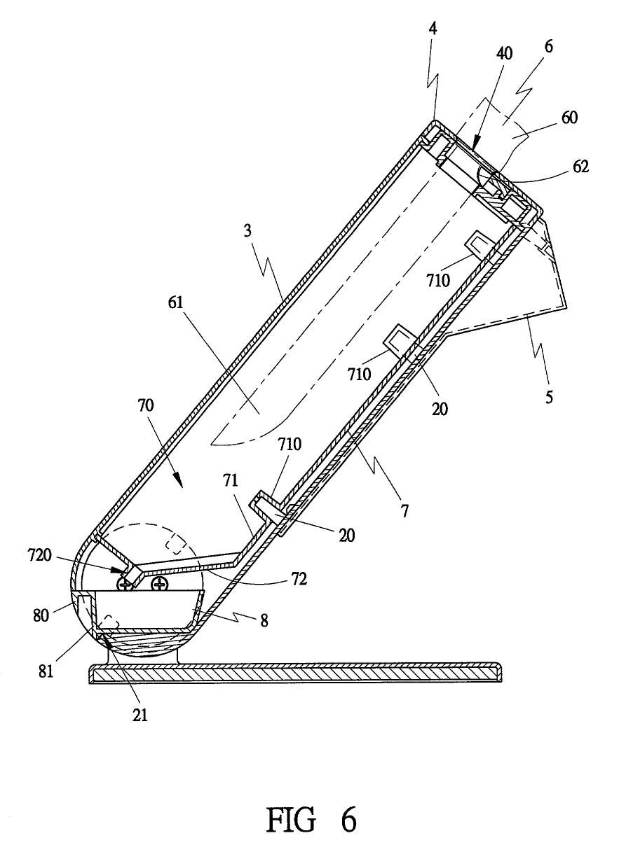

The knife groove base 7 has an open knife groove 70 and a plurality of combining grooves 710 formed on a bottom wall 71 for receiving the combining studs 20 of the front shell 2 and combining them together. Then, the rear shell 3 is provided with an insert groove 30 for the wall 711 of the knife groove base 7 to insert therein, as shown in FIG. 5, and to combine the knife groove base 7 with the shell bodies 2, 3 together. Besides, a downward slope 72 is provided under the knife groove base 7 and has a water-guiding hole 720 bored at the bottom for guiding the water dropping down from the knife blades 61 into a water-collecting tray 8, as shown in FIG. 6.

The ultraviolet disinfecting lamp 73 is installed in the knife groove base 7 and secured in a fitting groove 74 at a lower portion of the knife groove base 7. The ultraviolet disinfecting lamp 73 is covered around by a shade 730 on an upper portion for protection and fixed on the inner wall of the knife groove base 7 by means of a screw 731 and also covered by a bottom cover 732 around its bottom portion and fixed with the knife groove base 7 by a screw 733 screwing from outside. Thus, the ultraviolet disinfecting lamp 73 is secured stably and capable to prevent water from seeping in and, after making electric connection, the ultraviolet light emitted from the ultraviolet disinfecting lamp 73 will shine into the knife groove 70 to disinfect the knife blades 61 therein.

While the preferred embodiment has been described above, it will be recognized and understood that various modifications may be made therein and the appended claims are intended to cover all such modifications that may fall, within the spirit and scope of the invention.

What is claimed is:

1. A disinfecting device of a knife holder comprising an ultraviolet disinfecting lamp secured in a knife groove base of a knife holder consisting of a front shell and a rear shell combined together to form a shell body covered by an upper cover, said upper cover having a plurality of insert holes provided spaced apart for knives to insert therein, with the knife blades inserted deeply into the knife grooves of a knife groove base, said front shell provided on a front surface with a faceplate having press buttons and an indicating device;
Said knife groove base having said knife grooves and a plurality of combining grooves formed on the lower wall for the combination studs of said front shell to insert therein and combine said knife groove base with said front shell together;
Said ultraviolet disinfecting lamp installed in said knife groove and firmly positioned in a fitting groove under said knife groove base and covered around by a shade on an upper portion for protection and fixed with a bottom cover at a lower side, thus said ultraviolet lamp secured stably in place and capable to prevent water from seeping in, said ultraviolet lamp emitting ultraviolet light to shine into said knife grooves to disinfect said knife blades therein.
